(19) United States
(12) Patent Application Publication
(10) Pub. No.: US 2014/0115104 A1
(43) Pub. Date: Apr. 24, 2014

(54) Method and Apparatuses for Interchanging Data

(71) Applicants: Jörg Heuer, Oberhaching (DE); Sebastian Käbisch, Munchen (DE); Daniel Peintner, Meransen Muehlbach (IT)

(72) Inventors: Jörg Heuer, Oberhaching (DE); Sebastian Käbisch, Munchen (DE); Daniel Peintner, Meransen Muehlbach (IT)

(21) Appl. No.: 14/126,301

(22) PCT Filed: Jun. 13, 2012
(86) PCT No.: PCT/EP2012/061220

§ 371 Date: Dec. 13, 2013

(30) Foreign Application Priority Data
Jun. 14, 2011 (DE) 102011077476.9
May 31, 2012 (EP) EP12170271

(51) Int. Cl. H04L 29/08

(52) U.S. Cl. CPC H04L 67/02
USPC 709/217

(57) ABSTRACT

The invention describes a method for interchanging data between a transmitter (1) and a receiver (2). The interchange of data is based on grammar (22) known to the transmitter (1) and to the receiver (2). In the method according to the invention, if the grammar (22) in the transmitter (1) differs from the known grammar (22), the known grammar (22) of the receiver (2) is adapted to the differing grammar (22) of the transmitter (1) in an initialization phase at the beginning of data interchange or between the actual propagation time of the data transmission between the transmitter (1) and the receiver (2).

The invention relates to a method and apparatuses for interchanging data between a transmitter and a receiver, wherein the data interchange is based on a grammar that is known to the transmitter and the receiver.

When using efficient coding methods for XML (Extensible Markup Language), in many cases it is assumed that a transmitter and a receiver have agreed on a shared knowledge, e.g. in the form of a known XML Schema, prior to the actual transmission of data. By way of example, when what is known as Schema Informed Mode is used, this applies to EXI (Efficient XML Interchange) or MPEG BiM (binary MPEG format for XML). EXI is a format for the binary representation of XML information sets. In comparison with text-based XML documents, documents in EXI format can be processed more quickly and require less bandwidth for transfer via a communication link.

The shared knowledge is used for the efficient representation of XML data. In this case, information contained in the shared knowledge is not used in the data stream a further time, but rather is replaced by reference to information contained in the shared knowledge, which means that the actual volume of data for the transmission can be kept small. The agreement on shared knowledge prior to the actual transmission is difficult or impossible in many areas of application. This then results in it not being possible to resort to shared knowledge in order to reduce the data stream for a data interchange. In a worst case, data interchange is even not possible at all.

The use of efficient coding methods for XML is important for “embedded systems”, for example. Such systems are used within the context of electric vehicles, for example, in which information is interchanged between an electric vehicle and a charging station by means of XML, for example. In this context, one requirement is, inter alia, that there must be both forward and backward compatibility between earlier and the latest versions of the XML Schemas of both components. In this case, the settlement on a shared knowledge has some associated complexity.

It is an object of the present invention to specify a method and apparatuses for more efficient interchange of data between a transmitter and a receiver that use a coding method for XML.

This object is achieved by a method according to the features of patent claim 1 and by apparatuses according to the features of patent claims 15 and 16. Advantageous refinements can be found in the dependent patent claims.

In the case of the inventive method for interchanging data between a transmitter and a receiver, wherein the data interchange is based on a grammar that is known to the transmitter and the receiver, that is available in the transmitter and in the receiver and that has been derived from an XML Schema, DTD or RNG, for example, if there is a discrepancy in the grammar in the transmitter from the known grammar then the known grammar of the receiver is brought into line with the differing grammar of the transmitter in an initialization phase at the beginning of the data interchange or between the actual runtime of the data transmission between the transmitter and the receiver.

In the case of the inventive method, a shared knowledge (shared coding knowledge) in the form of grammars that have been brought into line in the transmitter and in the receiver is set up prior to the actual transmission of the useful data, said shared knowledge subsequently being able to be taken as a basis or shared knowledge for all further messages. Prior to the alignment, the shared knowledge consists in the known grammar, and after the alignment it consists in the known and the differing grammar. This allows data to be transmitted between transmitter and receiver very compactly and efficiently even when no settlements have been made or have been able to be made beforehand.

As a person skilled in the art knows, a grammar is a coding and decoding instruction for an XML document, a data structure that is equivalent to XML or a memory representation of an XML document, for example as a document object model, DOM, for a coding device. A decoding device uses the grammar as an instruction in order to take a received data stream and create an XML document, a data structure that is equivalent to XML or a memory representation of an XML document.

Expediently, the known grammar is brought into line with the differing grammar exclusively in the initialization phase. By contrast, differences in the grammar of the transmitter and of the receiver are no longer brought into line during the runtime. In this case, the term “during the runtime” is intended to be understood to mean the actual transmission of useful data between the transmitter and the receiver.

In a further expedient refinement, at least the differences between the known and the differing grammar are transmitted from the transmitter to the receiver in the initialization phase. Similarly, it is possible to transmit the complete grammar of the transmitter to the receiver, as a result of which the receiver can take a comparison between the received differing grammar of the transmitter and its own grammar as a basis for extracting the differences and processing them to form a decoding or coding instruction.

In a further expedient refinement, the known grammar is brought into line with the differing grammar in the receiver by virtue of the receiver learning the useful data transmitted in the initialization phase.

In a further expedient refinement, the known grammar is identified before or at the start of the initialization by virtue of an identifier being transmitted. An example of such an identifier may be a namespace in an XML Schema definition.

The distinction between the initialization phase and “during the runtime” is important particularly within the context of embedded systems, since learning is usually unpredictable in terms of the use of the memory, the timing response and the computation power of the embedded system. In the case of embedded systems, learning at runtime sometimes leads to an infringement of the limits of memory, timing response and computation power, which means that in a worst case the result may be a system failure. In the case of embedded systems, learning during the runtime should therefore be avoided or limited to suitable times in the runtime at which the aforementioned restrictions are not important. The proposed method avoids this by virtue of the learning taking place in the initialization phase, i.e. a dedicated phase prior to or between the actual runtime of the data transmission. In the initialization phase, it is possible particularly for the receiver that is performing the learning to decide whether the hardware resources required in the learned information are available to a sufficient degree at the receiver end. It is thus possible for the learning and hence the alignment of the grammar to be terminated if necessary. It is also evident from this description that the differences in the grammar of the transmitter and the receiver are learnt from the receiver, which comprises the decoder for the data transmitted by the transmitter.

The agreement on a shared knowledge prior to the actual transmission of useful data can be made in different ways.

In a first variant, an agreement on shared knowledge is made on the basis of the transmission of at least one message, particularly one that precedes the runtime, in the initialization phase. In this case, the initialization phase comprises at least the first message transmitted from the transmitter to the receiver, which message allows the receiver to bring the initially still different grammars in the transmitter and receiver into line with one another. In particular, the message(s) transmitted in the initialization phase is or are evaluated by a decoder in the receiver. By contrast, the message(s) transmitted in the initialization phase is or are rejected by an application in the receiver after the decoding. This means that the message(s) transmitted in the initialization phase correspond(s) to the useful data and is or are not processed further by an application in the usual manner after decoding, since the information contained in the message(s) from the initialization phase is suitable only for teaching the grammar and cannot usefully be processed by the application.

By way of example, an XML document comprising the discrepancy can be transmitted from the transmitter to the receiver. Similarly, it is possible for at least altered constructs from the differing grammar to be transmitted to the receiver. In the first message, and optionally further messages from the initialization phase, all changes relating to the data structure and the data types are therefore transmitted to the receiver, for example as example instances that are as space-saving as possible. This includes not only added changes to the data structure and the data types but possibly also data structures and types that have been removed from the XML document. In the case of XML Schema, for example, all constructs (particles) from an XML Schema that need to be brought into line are transmitted to the receiver.

The changes are mapped on the basis of a prescribed codec in the receiver. By way of example, element data can be allocated to an identifier that can then be stored in a table (as is implemented in the case of EXI, for example, with string tables). During the runtime of the data interchange between transmitter and receiver, the element name then no longer needs to be transmitted. It is sufficient merely to refer to the identifier. In addition, it is furthermore possible for the individual elements to be allocated a type property that is likewise stored in the string table. In this case, conversion of a transmitted string to a numerical value can be dispensed with, since the relevant information about the type of processing can be taken from the string table. This allows the efficiency of the transmission method to be improved.

Alternatively, the information about the locations at which a discrepancy occurs can be captured in the shared knowledge.

The first variant has the advantage that existing decoders can be used in the receiver in order to perform alignment of the grammar in the transmitter and in the receiver.

In the case of the second variant, the differing grammar is transmitted to the receiver directly in the initialization phase. In this variant, the grammar to be used for coding and decoding is made available to the decoder prior to the runtime. By way of example, the first message that contains the grammar may be labeled, as a result of which the decoder in the receiver recognizes that said message contains the grammar that is required for the further decoding. The label may also be used for initialization by supplying it to an interface that is associated with the processing of the grammar in a runtime environment of the decoder. By way of example, the signaling can take place at transport level, e.g. layer 5 or 6. In this second variant, the grammar is supplied, by way of example, to a grammar interface in the runtime environment of the decoder in the receiver in order to process the decoding instruction produced from the grammar.

The invention also provides a coding device in a transmitter for interchanging data between the transmitter and a receiver, wherein the data interchange is based on a grammar that is known to the transmitter and the receiver and that is designed so that if there is a discrepancy in the grammar in the transmitter from the known grammar then it brings the known grammar in the receiver into line with the differing grammar in the transmitter in an initialization phase at the beginning of the data interchange between the transmitter and the receiver.

By way of example, the transmitter can transmit all of its knowledge to the receiver in advance, e.g. as an EXI grammar form or as a table form. In this case, it is not necessary first of all to determine where the differences in the grammars lie. Alternatively, it is possible for the grammars to be brought into line by interchanging identifiers.

The invention also provides a decoding device in a receiver for interchanging data between a transmitter and the receiver, wherein the data interchange is based on a grammar that is known to the transmitter and the receiver and that is designed so that if there is a discrepancy in the grammar in the transmitter from the known grammar then it brings the known grammar in the receiver into line with the differing grammar in the transmitter in an initialization phase at the beginning of the data interchange between the transmitter and the receiver.

Furthermore, the coding device and the decoding device may comprise further means for carrying out the method described above.

The embodiments described above each have the following advantages:

Very flexible agreement on a shared knowledge is possible without any arrangements prior to the actual transmission. The approach allows very high compression rates to be attained, in identical fashion to what is known as pre-agreed shared knowledge. There are no version control problems when the XML Schema or the grammar derived therefrom, i.e. the agreed shared knowledge, changes. In this case, the approach described above is carried out again in the initialization phase for every alteration. Finally, the approach is a transparent method for the applications that already use pre-agreement today. There is no need for adjustment of EXI libraries in order to achieve XML Schema version control.

The invention is explained in more detail below with reference to an exemplary embodiment in the drawing, in which:

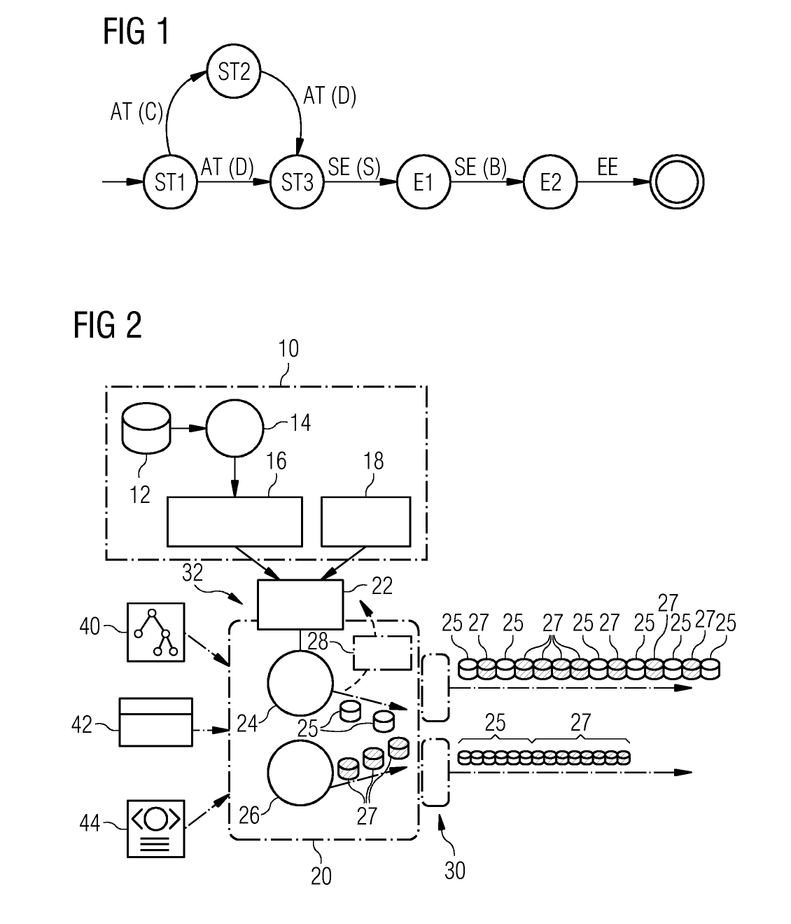

FIG. 1 shows an example grammar in order to create EXI codes,

FIG. 2 shows a known flowchart for the coding of data at the transmitter end,

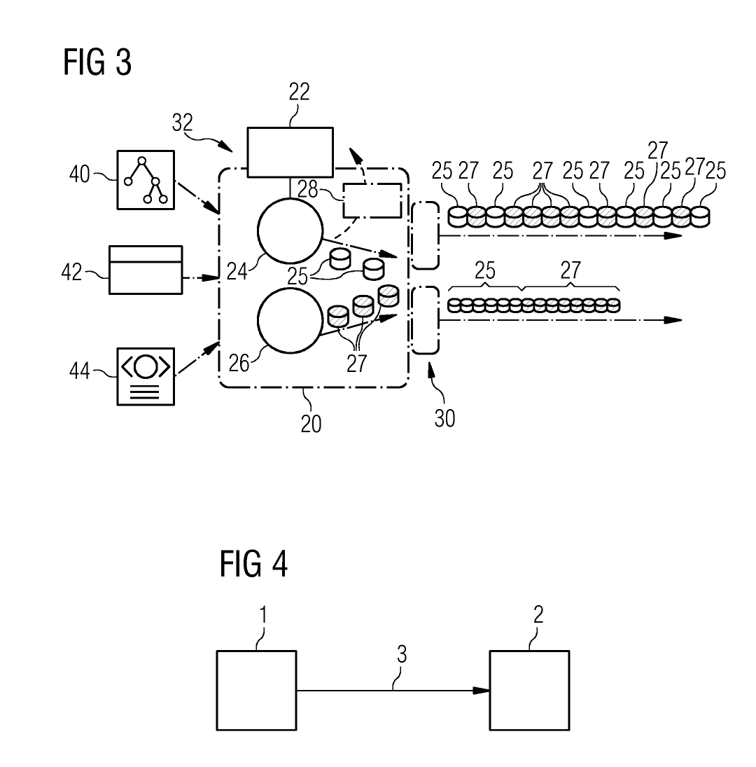

FIG. 3 shows a flowchart for the coding of data at the transmitter end in which the inventive approach is illustrated, and

FIG. 4 shows a transmitter and a receiver that have been set up in a manner according to the invention for the interchange of data.

The inventive method for interchanging data between a transmitter 1 and a receiver 2 via a communication link 3 involves data interchange taking place on the basis of a grammar that is known to the transmitter 1 and the receiver 2. This grammar may have been derived from an XML Schema, a DTD (Document Type Definition) or an RNG (RELAX NG) definition, for example.

There is the possibility of applications for the use of XML-schema-based data interchange, in which a discrepancy from a formerly agreed, known XML Schema is possible in the transmitter 1. By way of example, this is the case when the XML Schema that is used for decoding the interchanged data cannot be updated in the receiver 2. The approach described below provides a way of still obtaining a high level of efficiency for the XML-based data interchange when there are different XML Schemas in the transmitter 1 and the receiver 2.

The method described below uses EXI (Efficient XML Interchange) for the binary representation of XML information sets. The EXI grammar associated with the XML Schema presented below is shown schematically in FIG. 1.

```
<xs:complexType name=“Note”>
  <xs:sequence>
    <xs:element name=“S” type=“xs:string”/>
    <xs:element name=“B” type=“xs:string”/>
  </xs:sequence>
  <xs:attribute name=“D” type=“xs:date” use=“required”/>
<xs:attribute name=“C” type=“xs:string” use=“optional”/>
</xs:complexType>
```

ST1, ST2, ST3, E1 and E2 denote states of the execution sequence for the EXI code. ST1 represents a start tag 1, ST2 represents a start tag 2, ST3 represents a start tag 3, E1 represents an element 1 and E2 represents an element 2. AT(C), AT(D), SE(S), SE(B) and EE denote transitions between the states. AT(C) stands for AT(Category), AT(D) stands for AT(Date), SE(S) stands for SE(Subject) and SE(I) stands for SE(Body). AT represents an attribute, and SE represents a start element, FIG. 1 therefore shows a decoding sequence that maps a piece FIGS. 2 and 3 each show a flowchart for the coding of data on the transmitter 1, once in known, conventional fashion (FIG. 2) and once in inventive fashion (FIG. 3).

Reference symbol 10 denotes a configuration time environment that is provided in the conventional flowchart shown in FIG. 2. In said environment, a given XML Schema 12 is converted by a schema compiler 14 into a grammar that is stipulated by the schema (reference symbol 16). Reference symbol 18 denotes a predefined grammar (built-in grammar). From the grammars 16, 18, a grammar 22 for a runtime environment 20 is produced that is used for coding data that are to be interchanged. The grammar 22 produced is supplied to the runtime environment 20 via a nonstandardized interface (e.g. EXI grammar interface). From the grammar 22, it is possible to process input data supplied to the runtime environment 20 to form a binary stream using structure coding 24 and a device 26 for content coding.

The runtime environment can be supplied with the input data in file or text form. By way of example, reference symbol 40 represents a memory representation of an XML that is also called a Document Object Model (DOM). Reference symbol 42 represents a data structure that is equivalent to XML. An XML document is denoted by reference symbol 44. The input data 40, 42, 44 can be available and supplied to the runtime environment 20 in one of the types described. The devices 24 and 26 produce the binary stream therefrom, which is denoted by reference symbols 25 and 27. In this case, reference symbol 25 represents coded structure information, and reference symbol 27 represents coded content information. These can be transmitted to the receiver 2 via an interface 30 in an order that arises according to the coding (upper binary stream) or in a rearranged and compressed “order” (lower binary stream) for the purpose of decoding. The interface 30 is also called an EXI interface. This interface is standardized.

The flowchart shown in FIG. 2 is present both on the transmitter and on the receiver in known communication systems. On the receiver, the binary stream then forms the input data that are supplied via the EXI interfaces to the devices for structure and content coding in order to produce the structure and the content. The XML document, the memory representation or the data structure that is equivalent to XML are the only output data from the receiver.

In the case of the inventive approach, the components contained in the configuration time environment 10 can be dispensed with on the receiver 2. In one variant, this is made possible by virtue of the grammar 22 that is required for the operation of the transmitter and receiver being produced by the transmitter and then transmitted to the receiver in an initialization phase prior to the actual runtime of the data interchange. All of the information contained in the grammar 22 may be contained in a first message that is transmitted from the transmitter 1 to the receiver 2.

This message is preferably labeled, so that the receiver 2 is able to recognize that it is used for initializing the decoder. This supplies it not to the EXI interface 30 of the runtime environment but rather to the nonstandardized interface 32. Signaling, i.e. labeling, that the first message contains a grammar can be effected at transport level, e.g. layer 5, for example. Once the receiver 2 has received the grammar 22, it processes it in customary fashion. In particular, the information required for the structure decoding is adjusted, where necessary. The same likewise applies to the coding of the content using the device 26.

If, in an alternative variant, the shared knowledge about one or more preceding messages is set up in an initialization phase at the beginning of the data interchange between transmitter 1 and receiver 2, this data interchange takes place via the EXI interface 30. In the message(s) from the initialization phase, the transmitter 1 notifies the receiver of all of the changes to the data structure and the data types that are to be made in the XML document from the receiver. The message or messages in the initialization phase generally comprise(s) all or all changeable constructs (particles) in an XML Schema. As soon as these have been received by the receiver via the interface 30, they are mapped by means of an ad-hoc grammar device 28 in the receiver, as a result of which the grammar 22 of the receiver is brought into line with the grammar 22 of the transmitter 1. The further messages after the initialization phase then use the shared knowledge in order to keep down the volume of data to be transmitted.

By way of example, the messages transmitted in the message(s) of the initialization phase may be strings that are used in EXI to pre-fill string tables. In this context, recurring strings can be provided with identifiers, so that only the identifier needs to be coded in the messages at runtime instead of a text string. To increase efficiency, it is furthermore possible for a data record to be provided with a type property. As a result, data used at runtime can also refer to a type, so that it is not necessary for a type conversion method to be carried out on the receiver, for example.

Overall, this approach allows flexible agreement on shared knowledge without any arrangements prior to the actual transmission. It is possible to attain very high compression rates. Furthermore, there are no version control problems when the XML Schema changes on the transmitter. A further advantage is that the method is transparent for applications that already use the “pre-agreement” methodology today. In this case, no adjustments to EXI libraries are necessary in order to achieve XML Schema version control.

1. A method for interchanging data between a transmitter (1) and a receiver (2), wherein the data interchange is based on a grammar that is known to the transmitter (1) and the receiver (2), in which if there is a discrepancy in the grammar in the transmitter (1) from the known grammar then the known grammar of the receiver (2) is brought into line with the differing grammar of the transmitter (1) in an initialization phase at the beginning of the data interchange or between the actual runtime of the data transmission between the transmitter (1) and the receiver (2).

2. The method as claimed in claim 1, in which the known grammar is brought into line with the differing grammar exclusively in the initialization phase.

3. The method as claimed in claim 1, in which differences in the grammar of the transmitter (1) and of the receiver (2) are not brought into line during the runtime.

4. The method as claimed in claim 1, in which at least the differences between the known and the differing grammar are transmitted from the transmitter (1) to the receiver (2) in the initialization phase.

5. The method as claimed in claim 1, in which the known grammar is brought into line with the differing grammar in the receiver (2) by virtue of the receiver (2) learning the useful data transmitted in the initialization phase.

6. The method as claimed in claim 1, in which the known grammar is identified before or at the start of the initialization by virtue of an identifier being transmitted.

7. The method as claimed in claim 1, in which the initialization phase comprises at least the first message transmitted from the transmitter (1) to the receiver (2).

8. The method as claimed in claim 7, in which the message(s) transmitted in the initialization phase is or are evaluated by a decoder in the receiver (2).

9. The method as claimed in claim 7, in which the message(s) transmitted in the initialization phase is or are rejected by an application in the receiver (2) for the purpose of decoding.

10. The method as claimed in claim 7, in which an XML document comprising the discrepancy is transmitted to the receiver (2).

11. The method as claimed in claim 7, in which at least altered constructs of a differing XML Schema are transmitted to the receiver (2).

12. The method as claimed in claim 1, in which the differing grammar (22) is transmitted to the receiver (2) in the initialization phase.

13. The method as claimed in claim 12, in which the grammar (22) is supplied to a grammar interface in a runtime environment in order to process a decoding instruction produced from the grammar (22).

14. The method as claimed in claim 1, in which the grammar (22) is derived from an XML Schema definition, Relax NG definition or a Document Type definition.

15. A coding device in a transmitter (1) for interchanging data between the transmitter (1) and a receiver (2), wherein the data interchange is based on a grammar that is known to the transmitter (1) and the receiver (2) and that is designed so that if there is a discrepancy in the grammar in the transmitter (1) from the known grammar then it brings the known grammar of the receiver (2) into line with the differing grammar of the transmitter (1) in an initialization phase at the beginning of the data interchange between the transmitter (1) and the receiver (2).

16. A decoding device in a receiver (2) for interchanging data between a transmitter (1) and the receiver (2), wherein the data interchange is based on a grammar that is known to the transmitter (1) and the receiver (2) and that is designed so that if there is a discrepancy in the grammar in the transmitter (1) from the known grammar then it brings the known grammar of the receiver (2) into line with the differing grammar of the transmitter (1) in an initialization phase at the beginning of the data interchange between the transmitter (1) and the receiver (2).
